(19) United States
(12) Patent Application Publication
(10) Pub. No.: US 2025/0392064 A1
(43) Pub. Date: Dec. 25, 2025

(54) CABLE ASSEMBLY

(71) Applicants: FOXCONN (KUNGSHAN) COMPUTER CONNECTOR CO., LTD., Kunshan (CN); FOXCONN INTERCONNECT TECHNOLOGY LIMITED, Grand Cayman (KY)

(72) Inventors: YU GONG, Huaian (CN); A-Nan Yang, Huaian (CN); Han-Run Xie, Huaian (CN); Wu Wen, Huaian (CN); Lu-Yu Chang, New Taipei (TW)

(21) Appl. No.: 19/244,083

(22) Filed: Jun. 20, 2025

(30) Foreign Application Priority Data
Jun. 25, 2024 (CN) 202421462826.5

(51) Int. Cl. H01R 12/53; H01B 7/02; H01R 12/57

(52) U.S. Cl. CPC H01R 12/53; H01B 7/0216; H01R 12/57

(57) ABSTRACT

A cable assembly includes: a cable having an inner conductor, the inner conductor having a conductor contact portion; and a printed circuit board connected to the cable; wherein the printed circuit board includes a metal connection portion, and the conductor contact portion is mechanically and electrically connected to the metal connection portion by a cold welding process.

### BACKGROUND OF THE INVENTION

### Field of the Invention

The present invention relates generally to a cable assembly used to transmit high frequency signals.

### Description of Related Arts

The traditional way of soldering a cable to a printed circuit board is to manually solder the cable to the printed circuit boards (PCB) using solder and soldering irons. The improved method of soldering cables to a printed circuit boards is to use hot bar soldering machine to print solder paste on the soldering pads of the printed circuit board first, then use a pulse current to flow through molybdenum, titanium, etc., with high resistance characteristics to generate huge Joule heat to heat the hot bar; and finally the hot bar heats and melts the solder paste printed on the PCB soldering pads to achieve the purpose of soldering. More advanced is laser soldering, which is a non-contact soldering process suitable for ultra-small circuit boards and high-temperature sensitive components. It uses controllable laser pulse width, energy, peak power and repetition frequency to accurately control the heating area and time to avoid damage to components on the circuit board.

Although hot bar soldering and laser soldering are more time-saving and improve product yield compared to traditional manual soldering iron, they still rely on solder or other solder paste and flux to achieve soldering between electronic components at high temperatures; the high-temperature soldering process will introduce thermal stress, and rapid heating and cooling can easily cause the PCB to expand and contract, and even crack the internal circuits; the thickness of the solder on the pad and the uniformity of the solder between each soldering pads will also affect the finished electrical characteristics of the entire cable circuit board assembly. Because of the use of solder, the characteristic impedance at the solder point between the connector and the cable is relatively high, which will affects the impedance matching between the connector and the cable, resulting in poor SI such as return loss.

Therefore, it is desired to provide an improved cable assembly with good electrical performance.

### SUMMARY OF THE INVENTION

A main object of the present invention is to provide a cable assembly with good electrical performance.

To achieve the above object, a cable assembly includes: a cable having an inner conductor, the inner conductor having a conductor contact portion; and a printed circuit board connected to the cable; wherein the printed circuit board includes a metal connection portion, and the conductor contact portion is mechanically and electrically connected to the metal connection portion by a cold welding process.

Compared to prior art, in the present invention, the inner conductor and the metal connection portion are mechanically and electrically connected together through a cold welding process, so that the electrical performance of the cable assembly is good.

### BRIEF DESCRIPTION OF THE DRAWING

FIG. 1 is a top view of a traditional cable soldered onto a printed circuit board;

FIG. 2 is a side view of a first embodiment of a cable assembly of the present invention;

FIG. 3 is a side view of a second embodiment of a cable assembly of the present invention; and

FIG. 4 is a side view of a third embodiment of a cable assembly of the present invention.

### DETAILED DESCRIPTION OF THE PREFERRED EMBODIMENT

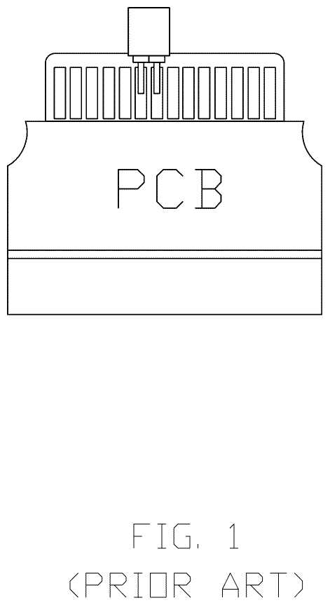

FIG. 1 shows a traditional cable with conductors soldered to the soldering pads of a printed circuit board.

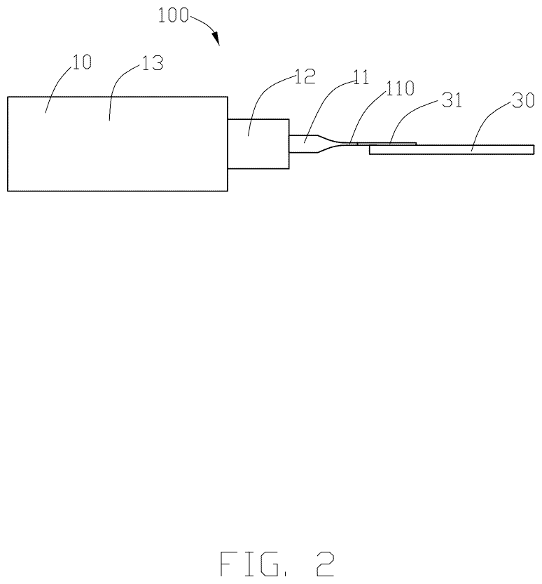

FIG. 2 shows the first embodiment of the cable assembly 200 of the present invention. The cable assembly 100 includes a cable 10 and a printed circuit board 30 that can be mechanically and electrically connected to the cable 10. The printed circuit board 30 can be used in an electrical connector (not shown). The printed circuit board 30 includes a metal connection portion 31 connected to the cable 10.

The cable 10 comprises a pair of inner conductor 11, an inner insulating layer 12 covering the pair of inner conductor 11, and an outer insulating layer 13 covering the inner insulating layer 12. Each of the inner conductors 11 includes a conductor contact portion 110 connected to the printed circuit board 30.

Each of the inner conductor 11 of the cable 10 and a corresponding metal connection portion 31 are mechanically and electrically connected by a cold welding process. The present invention uses a cold welding process to expand the contact surface area of the two parts to be connected under the action of concentrated pressure load, so as to break the oxide film or coating that hinders welding and expose the pure metal to produce inter-atomic bonding. The strength and resistance of the joint portion are the same as those of the busbar.

The metal connection portion 31 is flat and roughly rectangular. The cable 10 needs to be pre-processed before being assembled on the printed circuit board 30. After cutting and laser stripping, the inner conductor 11 of the cable 10 is exposed. Then, the front end of the exposed inner conductor 11 of the cable 10 is extruded into a flat shape to form the conductor contact portion 110. Then, the metal connection portion 31 and the conductor contact portion 110 are connected through a cold welding process, thereby realizing a solderless assembly between the cable 10 and the printed circuit board 30. The cross-sectional shape of the inner conductor 11 except the conductor contact portion 110 is circular. Of course, the inner conductor 11 may also be entirely flat. The metal connection portion 31 extends forward beyond the front edge of the printed circuit board 30. The metal connection portion 31 and the conductor contact portion 110 are cold-connected together along the longitudinal direction of the cable by a cold pressing machine.

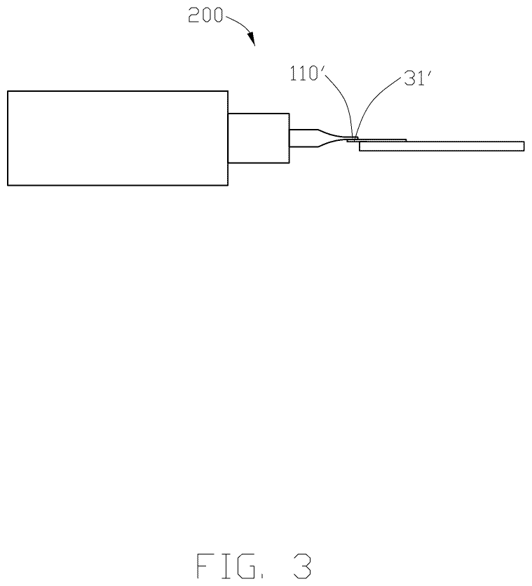

FIG. 3 shows the second embodiment of a cable assembly 200 of the present invention. Compared with the first embodiment, in this embodiment, the metal connection portion 31′ and the conductor contact portion 110′ are cold-connected in a vertical direction perpendicular to the longitudinal direction of the cable by a cold-pressing machine.

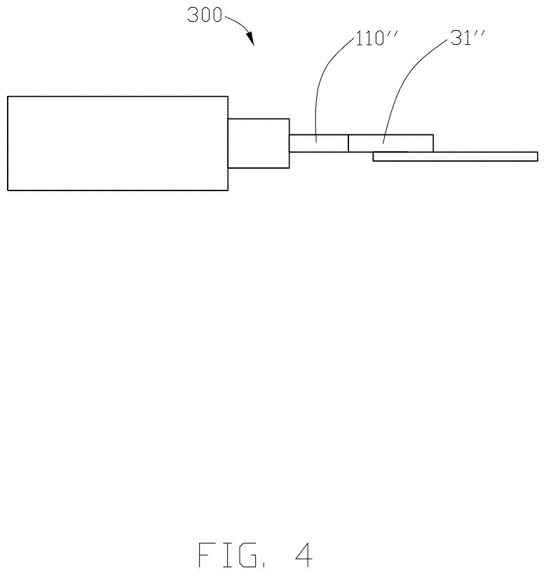

FIG. 4 shows the third embodiment of a cable assembly 300 of the present invention. Compared with the first embodiment, in this embodiment, the cross-sectional shape of the conductor contact portion 110″ is circular, and the shape of the metal connection portion 31″ is a circular shape to match the shape of the conductor contact portion 110″.

In other embodiments, the cross-sectional shape of the conductor contact portion may be rectangle, and the shape of the metal connection portion may also be rectangle.

The material of the metal connection portion of most printed circuit boards 30 is pure copper with tinned surface to match the material of the inner conductor of the cable. The material of the metal connection portion of the printed circuit board can also be changed according to the material of the inner conductor of the adapted cable.

In the present invention, the inner conductor of the cable is mechanically and electrically connected to the metal connection portion of the printed circuit board through the cold welding technology. The printed circuit board and the cable are integrated purely by the combination of metal atoms without relying on other media, which greatly reduces the impedance of the joint point, improves the matching degree between the conductor contact portion 110 of the cable and the metal connection portion on the printed circuit board, and is conducive to improving the electrical characteristics.

1. A cable assembly comprising:
a cable having an inner conductor, the inner conductor having a conductor contact portion; and
a printed circuit board connected to the cable; wherein
the printed circuit board includes a metal connection portion, and the conductor contact portion is mechanically and electrically connected to the metal connection portion by a cold welding process.

2. The cable as claimed in claim 1, wherein the shape of the conductor contact portion matches the shape of the metal connection portion.

3. The cable as claimed in claim 2, wherein the metal connection portion is rectangular, and the conductor contact portion is flat.

4. The cable as claimed in claim 3, wherein the cross-section shape of the inner conductor is circular except for the conductor contact portion.

5. The cable as claimed in claim 2, wherein the cross-sectional shape of the conductor contact portion is circular, and the shape of the metal connection portion is also circular.

6. The cable as claimed in claim 2, wherein the cross-sectional shape of the conductor contact portion is rectangle, and the shape of the metal connection portion is also rectangle.

7. The cable as claimed in claim 2, wherein the metal connection portion extends forward beyond a front edge of the printed circuit board.

8. The cable as claimed in claim 2, wherein the metal connection portion and the conductor contact portion are cold-connected together in a longitudinal direction of the cable by a cold pressing machine.

9. The cable as claimed in claim 2, wherein the metal connection portion and the conductor contact portion are cold-connected together in a vertical direction perpendicular to a longitudinal direction of the cable by a cold pressing machine.

10. The cable as claimed in claim 1, further including an inner insulating layer covering the pair of inner conductor and an outer insulating layer covering the inner insulating layer, and wherein the cable includes a pair of inner conductors spaced apart in a transverse direction.
